(19) United States
(12) Patent Application Publication
(10) Pub. No.: US 2005/0000127 A1
(43) Pub. Date: Jan. 6, 2005

(54) Dynamic optical grid providing more than two angles of view per viewer

(75) Inventor: Donald Lewis Martin, Mosman (AU)

Correspondence Address: MERCHANT & GOULD PC, P.O. BOX 2903, MINNEAPOLIS, MN, 55402-0903, US

(73) Assignee: TRUTAN PTY. LTD., Sydney (AU)

(21) Appl. No.: 10/634,195

(22) Filed: Sep. 3, 2004

Related U.S. Application Data
(63) Continuation of application No. 09/889,466, filed on Sep. 10, 2001, now abandoned.

(30) Foreign Application Priority Data
Jan. 18, 1999 (AU) PP 8204

(51) Int. Cl. G09F 19/14

(52) U.S. Cl. 40/453

(57) ABSTRACT

Three dimensional imagery composed of more than two angles of view to provide more than two visual references so that the eyes can scan and compare between more than two visibly distinct angles of view. Further provided is apparatus for viewing an imagery display, including means (10) for retaining the imagery display as a succession of images initiated at predetermined intervals. An optical grid means (20, 22) is arranged with respect to the imagery display retaining means so that the imagery display may be viewed through the grid means. Further included is means (30) for applying a control signal or signals to the optical grid means for causing progressive movement of transmissive (5) and opaque (4) zones across the means whereby the progressive moving transmissive zones provide a set of plural pairs of visually distinct angles of view of the imagery display able to be scanned by the left and right eyes respectively. The control signal is applied and the optical grid means is arranged so that the set of pairs of visually distinct angles of view is provided during each of the aforesaid intervals and therefore for each of the images. Also provided are related methods, an optical grid device, and a medium.

### FIELD OF THE INVENTION

This invention relates generally to the provision of three dimensional imagery, and in particular aspects is concerned with configurations, devices and techniques having utility in allowing a viewer of an imagery display to perceive a three dimensional impression of the display.

### BACKGROUND ART

General

Three dimensional imagery is a term that is used widely to imply imagery presenting visual depth although the imagery referred to may comprise any of a variety of quite different types of display. The main types contain a range of similarities extending from close to none, although this to some degree reflects the fact that depth perception is produced by a number of effects. Within any overall appreciation, however, three dimensional imagery can be divided into two firm categories. One is distinct as imagery containing one angle of view, the other can be defined as containing two visually distinct and complementary angles of view.

Imagery called three dimensional composed of one angle of view includes imagery in which depth effects are produced by display on mirrors as virtual imagery. Also, this category includes imagery containing impressions of depth produced by illustrative techniques. These techniques involve creating perspectives by shading, emphasising the edges of imagery against the centres through a practice called ‘the framing effect’, and moving individual aspects of the imagery while other parts remain stationary in contrast. The last technique is very ubiquitous and relies on the same effects for causing impressions of depth as those caused by panning a film or video camera slowly, or displaying moving objects captured on film or video. The change of angles of view produces a slight impression of visual depth which results from the changing angles of view being memorised partially and the slight angular differences in the views that are remembered being compared in the brain. All these examples are commonly found in computer graphics displays and in computer software packages providing these effects for specific purposes, particularly in industrial design and entertainment.

3D Spectacles

The second category comprises imagery containing two visually distinct angles of view which are always a view appropriate for left eyes and another visibly different complementary view appropriate for right eyes. Devices for presenting this imagery have characteristic designs, always incorporating features to exclude the left eye from seeing the right view and the right eye from seeing the left view. By far the most popular version of these systems require so called “3D spectacles”, a system that has both dominated and defined the meaning of stereography to both the sophisticated in the art and the general public since introduction last century.

The first popular version of a “two-view” device was the Holmes viewer. Viewers derived from the Holmes design that separated the twin views more definitely were developed gradually, leading to 3D spectacles, which are essentially viewers that are worn.

The latest 3D spectacles comprise small liquid crystal panels that open and close in coordination with film or video frame changes. These maintain the advantages of Polaroid spectacles to completely block and completely reveal all the colours of each image without incurring the severe light losses occasioned by polarising projector beams. 3D spectacles exist in several forms including stylised visors and helmets identifying product brands and display systems promoting three dimensional imagery under new names like virtual reality. As well, there are elaborations of the viewer system in various degrees of complexity where imagery is displayed to single observers at a time in fixed viewing positions.

This progression of improvements, extending over more than a century, has done nothing to alleviate the primary viewer problem of eyestrain and disorientation and cannot do anything to improve the discernment of spatial relationships through these systems. Regardless of sophistication, viewer, or spectacles, systems are inherently confined to displaying only two views, one for each eye.

Eyestrain has been a fundamental objection to 3D eyewear since viewers were first used for any length of time. Resistance to using viewers seems to have been manifested as soon as they were used for longer periods than the few moments required for looking at photographs. Reports of objections to using viewers because of eyestrain appear to coincide with the introduction of this system to cinema. Probably, it is the main reason for public rejection of viewers for nearly one hundred years and the main constraint on the development of a huge three dimensional imagery industry making enormous benefits available to most people.

Recently, another problem has arisen in the use of three dimensional viewer devices, particularly in remote control applications where remote manipulation is required at high levels of accuracy, ie. the failure of the viewer system to display sufficient visual reference for accurate discrimination of spatial relationships. There are numerous and important such applications, ranging from surgery to remote control and observation in dangerous and inaccessible situations typical of vital industrial activity such as mining, metal and oil production, and equally essential manufacturing situations at risk of human contamination like food processing. The remote operation of space vehicles where there are no external visual reference points for orientation is just one more example amongst an abundance of others.

Optical Grid Systems

Substitutes for three dimensional viewer systems are few, holography and optical grid systems being by far the best developed to date. In the case of holography current technology is incapable of displaying holograms containing movement except in limited circumstances and with highly specialised equipment. Developments of optical grid systems have flourished since the advent of liquid crystal panels made dynamic optical grids practical possibilities for the first time. Grid systems still suffer from the extent to which three dimensional imagery can be displayed completely over the 180 degree arc in front of any screen so as to present all aspects of the imagery in three dimensions to all possible viewing points, so that from any viewing point the eyes of any observer can scan freely through a complete visual volume in a manner closely approximating the normal human experience of visual dimension.

Optical grids, or parallax barriers as they are otherwise known, seem to be the oldest recorded device for displaying three dimensional imagery, dating to 1692 when a Danish painter, G. A. Bois-Clair, is reported to have fashioned a three dimensional double portrait displayed through wooden viewing slats.

Optical grids comprise rows of vertical parallel barriers and between the barriers rows of transmissive openings that are, usually, the same size and shape as the barriers. In operation the function of these systems is to provide different views to each eye of the overall view in front of the barrier. Each eye sees a different view in front of the barrier because it looks though the barrier from a different position determined by the different position of each eye in the head. As well, the barriers block different parts of the view in front to each eye.

The characteristic feature of these three dimensional imaging systems is rows of parts of images, or segmented imagery. Each eye sees through a restricted opening in a row of openings, so each eye sees parts of each view or image behind each opening which appear together as parts of a row of alternating segments of left and right images corresponding to the different and alternating positions of the segmented viewing positions of each eye. Probably, the most prolific of these systems is the so called “3D postcard”. These comprise alternating left and right segments of photographs positioned behind an optical grid in the form of a small lenticular array that displays two visibly distinct complementary views separately to each eye at the focal point of the array of lenses.

The inherent limitation of these types of static optical grids is that they work mainly at the centre of the lens array when positioned precisely between the eyes at the focal point of the lens. Large lenticular arrays with focal points capable of accommodating more than one observer around a central viewing position exist and are incorporated in at least one brand of video monitor displaying three dimensional imagery without a requirement for viewers. The viewing area is small, however, and the requirement of viewers to maintain their eyes within the narrow viewing zone seems to be a serious limitation. Lenticular arrays are not capable of providing an unlimited viewing arc, or even a wide viewing arc.

The first improvement to the static grid system was a dynamic mechanical grid introduced by Francois Savoy in 1945 to display three dimensional imagery without viewers. The concept, disclosed in British Patent 607,961, consisted of a circular grid that rotated to partially scan two visibly distinct complementary images projected on a screen. The cyclostereoscope, as it was called, neither separated either image to the appropriate eye completely nor presented either image completely at any viewing position. The images appeared broken up in zones so that each zone had to be viewed from a different viewing position. Savoy's patents included arrangements for seating within theatres where large barriers between sections of the seats restricted views from those positions to a coherent section of the imagery displayed in three dimensions. Despite the commercial failure of the cyclostereoscope and obvious severe limitations to any type of application, this invention was the pioneering effort from which all improvements in this field have flowed, albeit very slowly.

The introduction of liquid crystal displays provided a practical substitute for the dynamic mechanical grid, offering for the first time an opportunity to oscillate a large grid attached to a display screen at the very high speeds consistent with frame changes without incurring massive inertial effects such as uncontrollable vibration. A number of patent applications resulted promptly relating to displaying three dimensional imagery, with and without wearing viewers, such as British patent publication 2244624, German patent application 4123895, and Japanese Patent Application 8189/1991. Of these Japanese Application 8189/1991 was the first to propose correct principles for a visor-free liquid crystal display system. It also highlighted the specific difficulties that would have to be overcome to develop a practical system and, just as importantly, the difficulties that would have to be overcome to develop a commercially viable system.

As already foreshadowed, optical grids are applied to three dimensional imagery to perform two functions: firstly to display left views to left eyes and right views to right eyes, and, secondly, to block left views from right eyes and right views from left eyes. Both functions are essential, essential simultaneously, and the extent to which grids perform these two functions simultaneously determines both the efficiency of particular optical grid arrangements and the quality of three dimensional imagery displayed. It is well known that optical grids perform these combined functions poorly and the consequent three dimensional imagery displayed is poor. The reason for this is that any optical grid displays left and right imagery completely and separately to the appropriate eyes mainly from one viewing point. Improvements to optical grid performance, therefore, require both improving the number of viewing positions where left imagery is seen completely by left eyes and right imagery completely by right eyes. As well, it is necessary to improve the number of positions where left imagery is excluded completely from right eyes and right imagery excluded completely from left eyes. The solutions to these two improvements are related but not the same.

Optical grids formed on liquid crystal panels can be formed in any positions on these panels and reformed so that the transmissive elements of the grid and the opaque elements are positioned in any variety of positions. It is possible to vary the viewing positions of optical grids and thus the view separating and view blocking functions of any particular grid so formed in relation to any particular display of imagery situated at an appropriate viewing distance behind the grid.

The number of grid positions that can be formed within the period of the persistence of vision, any standard, or frame refresh, rate, is determined by the capability of display systems in conjunction with liquid crystal panels. Where three dimensional imagery is to be displayed a minimum of two images must be displayed to produce the effect. If the system as a whole is to operate at equivalent of the minimum conventional standard of PAL then the overall refresh rate must be 100 hertz for every combination of two complete complementary images. Each new position of the grid providing one new viewing position requires at least another 45 hertz to avoid obvious flicker, or 50 hertz if it is to conform to minimum international standards. In short, to provide as few as ten different viewing positions, far short of that required for an unlimited viewing position around a screen, the system would have to operate at between 450 and 500 hertz.

A second limitation arises through the fact that the more efficient the grid design the more restrictive the viewing position to the central focal point immediately outside of which nothing can be seen at all. In contrast grids that allow a broad viewing area beyond the central viewing zone not only do not display each appropriate image completely to each appropriate eye, the exclusion of inappropriate images to the eyes is also incomplete. This is because at positions away from the central viewing positions of optical grids it is possible for the eyes to see around and past the view blocking elements so that left eyes can see some of the right image and right eyes some of the left image. This means that for dynamic grids to be effective the segments of imagery positioned behind optical grids must be smaller in width than grid viewing sections so that the view blocking elements continue to block inappropriate views to the eyes at angles away from the central viewing position of the grid. To avoid crosstalk between the images the blocking elements of grids must be bigger than the image elements blocked, so for any position grids cannot display all of the imagery behind them and thus to display complete images must be positioned in more than one position to allow the whole image to be seen through the accumulation of the parts seen from any one vantage point. To display two images, as required for three dimensional imagery, optical grids must move through more than one viewing position to display each image completely.

The net effect of the requirement both to position optical grids at multiple positions to display images completely and to provide complete viewing positions over a wide arc, is display system refresh rates that may not be available in the foreseeable future. These two technical limitations are increased by the fact that it is desirable for optical grids to comprise very small transmissive and opaque elements so that they do not form visible segmentation of the imagery behind and can be placed as close to the imagery behind as possible to provide the widest arc of view through the grid to the display screen. This requirement for very small optical grid segments poses a further problem in that the smaller the segments become the more difficult it is to accurately align the grids with the imagery behind them. This third limitation, together with the previous two explained above, present limitations for which an entirely new approach is necessary.

It is a fundamental requirement of three dimensional imagery that at least two views are displayed to the eyes. As a consequence the frame refresh rate of any three dimensional display system using standard frame sizes must be halved effectively in order to display two frames completely during the same period conventional systems are designed to display one. Increasing frame rates to present complementary pairs of images for three dimensional displays without sub-standard flicker may be limited by the extent to which current display equipment can be modified within the foreseeable future, consequently no reliance can be found in any short term potential for frame rates to be increased sufficiently to both display multiple images as well as accommodate other additional time consuming functions such as changing optical grid viewing positions.

It is accordingly an object of the invention to provide for an improved concept in three dimensional imagery that at least in part alleviates the disadvantages of known three dimensional viewing systems.

### SUMMARY OF THE INVENTION

Principal Concepts

In a first aspect, the invention derives, firstly, from a realization that both the eyestrain inhibiting the use of 3D viewers and the failure of the viewer system to display sufficient visual reference for accurate discrimination of spatial relationships, are related. This relationship has its basis in a traditional concept of three dimensional perception and display that is simplistic to the extent of being misleading.

This concept is found throughout relevant literature, including university texts, and is espoused and accepted without comment or refinement in a plethora of patent applications as though it was a demonstrated fact, established beyond need of further critical examination or development. Essentially, it embraces the idea that each eye sees a different angle of view because of the different position of the eyes in the head and consequently the brain discerns spatial relationships from the angular differences between the two views. The twin foundations of this concept are the idea of two views, or two images, and the idea that the views, or images, are complete and mutually comparable for the distinction of visual depth conforming to actual physical dimension and distance. This concept can be shown to be substantially inadequate in both regards.

Secondly, it is the contention of the present applicant, based on experimentation, that the eyestrain suffered through using conventional visor and spectacle three dimensional imagery viewing systems may be caused by imposing abnormal eye functions. The stress induced in these circumstances appears to be magnified greatly by the display of large angles of view, in particular the very large angles of view required to make displayed imagery produce well known effects like appearing to ‘jump out of the screen’. The practice of creating excessive visual displacements of left and right images seems to be widespread. View point displacements consistent with the extreme angles of view presented for entertainment are not apprehended in normal visualisation. These effects are confined to and peculiar to two view type viewer systems which do not and cannot simulate natural sight. For systems using three dimensional imagery displays to facilitate remote control similar comments apply. Here, experimentation suggests that the larger the angle of view the more accurate the perception of dimension that can be obtained on displays of remotely acquired imagery. Unfortunately, the larger the angle of view displayed in viewers the more quickly and severely strain and distraction are likely to be experienced. It is not clear if any two angles of view by themselves, however large, can be sufficient ever for accurate discernment of spatial relationships on a screen, but it seems highly doubtful.

To overcome these problems and limitations it is proposed that three dimensional imagery should be composed of smaller rather than larger angles of view and displayed so that all aspects of both angles of view are in focus to allow the eyes to scan through the images in a manner more closely simulating normal visual activity. Most importantly the invention proposes improvements to systems displaying three dimensional imagery without the use of view differentiating spectacles so that the eyes can scan over the imagery on a screen freely without the central focal point direction of three dimensional viewers.

This depiction of sight conceives it not as a static geometric function, like the comparison of two fixed off-set photographs, in which angles between two different views are analysed by the brain to interpret depth, but as a dynamic function in which any two complete and visually distinct angles of view cannot be apprehended completely and simultaneously as one whole three dimensional image. This is in fact impossible. Instead, only parts of the total visual content within two appropriate complementary images are seen together in dimension at any distinct visual instant. In following instants the eyes refocus on other points of view, continuously combining partial three dimensional views into uninterrupted impressions of complete three dimensional views.

The eyes act as rapid scanners, constantly amalgamating varying parts of different pairs of focal points into an apparently even procession of comparative perspectives that cumulatively form perception of dimension. In short, the eyes scan and compare angles of view, viewer systems inhibit scanning, provide no comparative dimension, and in practice are used to display large angles of view in which sharp focus is concentrated at image centres further restricting opportunity for the eyes to behave normally by scanning and refocussing through the visual volume in front.

First Aspect of the Invention

In its first aspect, therefore, the invention proposes three dimensional imagery composed of more than two angles of view to provide more than two visual references so that the eyes can scan and compare between more than two visibly distinct angles of view.

The invention further provides, in its first aspect, apparatus for viewing an imagery display, including:
means for retaining said imagery display as a succession of images initiated at predetermined intervals;
an optical grid means arranged with respect to said imagery display retaining means so that the imagery display may be viewed through the optical grid means; and
means for applying a control signal or signals to said optical grid means for causing progressive movement of transmissive and opaque zones across the grid means whereby said progressively moving transmissive zones provide a set of plural pairs of visually distinct angles of view of the imagery display able to be scanned by the left and right eyes respectively;
wherein the control signal is applied and the optical grid means is arranged so that said set of pairs of visually distinct angles of view is provided during each of said intervals and therefore for each of said images.

Preferably, the control signal or signals include a progressive, or sequential, image scanning function horizontally across the panel simultaneously with a progressive, or sequential, three dimensional image tunnelling function so that imagery can be seen only by both eyes simultaneously, or substantially simultaneously, at multiple or all discernibly separate and exclusive viewing positions over a contiguous arc in front of the display retaining means that comprises the area where imagery can be distinguished clearly.

The imagery display retaining means may, eg., be a cinematograph, video and/or projection apparatus screen on which the images are retained, and the predetermined interval is then the refresh period of respective apparatus.

The number of pairs of visibly distinct angles of view may be an odd or even number but is preferably an even number.

The pairs of visibly distinct angles of view may be complementary about a common centre, parallel along a common horizontal axis, or may have different common centres to provide a variety of different comparable focal points, or so as to contain vertical displacement between angles of view.

The pairs of visibly distinct angles of view may be complementary, in parallel, and with different common centres along a horizontal axis, or complimentary in parallel or with different common centres to contain vertical displacement at angles to the vertical so as to display vertical as well as horizontal displacement and dimension. As well there may be mixtures of these types of angles of view.

Arrangements of views may be displayed as desired for different purposes as required but preferably at least four visibly different angles of view are displayed where two of the different angles of view have a different common centre to a common centre of the other two.

Angles of view may be displayed simultaneously or sequentially but always so as to appear simultaneous and preferably at a frame refresh rate sufficient to eliminate visible flicker, or at least avoid excessive flicker.

Every angle of view should be displayed in and to a different viewing position and advantageously no two different views may be displayed in or to the same viewing position during any sequence of display where persistence of vision could discern one view overlapping or superimposing on another view.

All angles of view displayed for the left eye are advantageously displayed exclusively and separately at positions for the left eye in any sequence of display where persistence of vision could discern a left view overlapping or superimposed on a right view, and not displayed completely, exclusively and separately to left eyes. All views displayed for the right eye are advantageously displayed exclusively and separately at positions for the right eye in any sequence of display where persistence of vision could discern a right view overlapping or superimposed on a left view, and not displayed completely, exclusively and separately to right eyes.

At all times displays of visual dimension composed of greater numbers of relatively small angles of view are preferred to displays of smaller numbers of relatively large angles of view.

Preferably, the angles of view do not exceed 15° as a greater angle of view is thought to be potentially harmful.

Second Aspect of the Invention

In one general embodiment of the first aspect of the invention, the optical grid means includes an optical grid device formed on an electro-optical panel or display, wherein the grid device is arranged so that its configuration may be altered within each of the aforesaid intervals (eg. each separate frame display) so that the grid device takes up plural, and preferably multiple or all, discernibly different viewing positions of the image display.

In a more particular embodiment of the first aspect of the invention, the optical grid means includes an optical grid device having multiple variable polarization elements controllable for altering the elements between opaque and transmissive conditions, wherein the elements have angles of polarisation that progressively vary across the device whereby the application to the device of a control signal or signals for effecting said alteration of the elements causes a progressive movement of transmissive and opaque zones across the device as the conditions of the elements are successively altered between opaque and transmissive.

More generally, in a second aspect of the invention, there is provided an optical grid device formed on an electro-optical panel or display, wherein the grid device is arranged so that its configuration may be altered within each of a series of associated image displays (eg. each separate frame display) so that the grid device takes up plural, and preferably multiple or all, discernibly different viewing positions of the image display.

In the second aspect of the invention, there is also provided an optical grid device having multiple variable polarization elements controllable for altering the elements between opaque and transmissive conditions, wherein the elements have angles of polarisation that progressively vary across the device whereby the application to the device of a control signal or signals for effecting said alteration of the elements causes a progressive movement of transmissive and opaque zones across the device as the conditions of the elements are successively altered between opaque and transmissive.

It will be appreciated that the second aspect of the invention may be adapted to the scanning of conventional “two-view” three-dimensional imagery, and is therefore not limited in its application to the first aspect of the invention.

In a particular embodiment, the optical grid device may include a three dimensional imagery optical grid of any required size, having parallel vertical strips of alternating opposite polarisation rotations through which two visibly distinct complementary angles of view are projected to form substantially aligned images on a screen composed of non polarisation diffusing material. The images are viewed through a second grid of vertical strips of alternating opposite polarisation rotations positioned and aligned so as to separate left images to left eyes and right images to right eyes.

Also provided is a three dimensional imagery viewing grid of any required size, having at least one layer of polarising material that comprises parallel vertical strips of polarised material forming an equal progression of increasing or decreasing polarisation rotation over the horizontal axis of the grid. Appropriate complementary angles of view may be rear projected onto a screen behind the grid comprising materials that do not diffuse polarisation. The imagery may be polarised in a rotating polariser or retarder so as to scan the different progressions of polarisation on the viewing grid and maintain separated and exclusive viewing positions for left and right imagery.

In a further variation of the second aspect of the invention, there is provided polarising material that includes alternating segments of opposite rotation.

Also provided is polarising material that includes progressively increasing or decreasing rotations in any direction, as a contiguous or sequential progression of increasing or decreasing angles of rotation.

The optical device may be an electro-optical panel including polarising materials, liquid crystal materials or materials analogous in properties and functions to liquid crystal materials, so as to produce an electro-optical panel within the context of what are described generally as liquid crystal panels or displays.

It is desirable that the provision of grid positions sufficient for all possible exclusive viewing positions is a function accomplished for each frame and within each frame display by optical grid elements scanning every viewing position across display screens in a configuration that alters continuously during each screen scan so as to display left and right imagery completely and exclusively to every discernibly different left and right viewing point.

The three dimensional imagery may be composed from drawings, illustrations, photographs, slides, films, video tapes, discs, microfiche and microchips, computer tapes discs and microchips, X-ray film tapes discs and microchips, infra-red photographs film tapes discs and microchips, ultra sonic film tapes discs and microchips, imagery generated wholly or partially in computers on film tapes discs or microchips, imagery acquired from CAD CAM equipment on film tapes discs or microchips, imagery acquired from CAT scanners on film tapes discs or microchips, and imagery acquired from other scanning functions such as resonance and absorption scanning on film tapes discs and microchips and from computer systems, programmes and specific purpose software packages. The imagery may be immediately displayed, recorded, stored, broadcast or transmitted.

Three dimensional imagery conforming to the stated definition may be obtained by drawing, illustration, programming computer systems and particularly computer graphics systems, software tapes discs and microchips, from cameras, operated so as to acquire two or more visibly distinct angles of view, or containing the capability of acquiring two or more visibly distinct angles of view, sensors, scanners and similar image acquiring, or producing, equipment operated to acquire or produce, or capable of acquiring or producing, two or more visibly distinct angles of view. The imagery may be displayed immediately, broadcast or transmitted for display, recorded or stored for future display.

Three dimensional imagery conforming to the stated definition may be recorded or stored on drawings, illustrations, slides, photographs, film, video tape, microfiche, discs, microchips and similar recording facilities for immediate or future display.

Three dimensional imagery conforming to the stated definition may be transmitted by broadcast, through networks particularly wire and optical fibre networks, and through networks serviced by satellite receivers, transmitters ground and relay stations.

Three dimensional imagery conforming to the stated definition may be received and displayed on display systems with the capability of conforming to the definition either directly or indirectly from recording or storage sources.

Third Aspect of the Invention

In a third aspect, the invention provides a medium in which are stored frames, representations, or machine readable code from which may be generated an imagery display including a succession of images initiated at predetermined intervals, the medium further storing machine readable code for generating the aforementioned control signal or signals for an optical grid means of the first aspect of the invention.

The medium may be a computer program or database product, or an electronic microchip, a videotape, CD-rom, or a video accelerator or other controller device, board or card.

Thus, in the third aspect of the invention, there are proposed cameras and associated recording equipment for acquiring or recording three dimensional imagery containing more than two discernibly distinct angles of view, where more than two views are acquired either completely separately, partially together and inclusively, or completely together and inclusively, on each separate frame of film or video cameras and where each frame is acquired or recorded with identifying data to identify the position of each frame, and where appropriate the position of each angle of view, in any sequence of frames, preferably for the purpose of controlling the positions of optical grid transmissive and opaque segmentation in relation to displaying discernibly different angles of view.

Also proposed are cameras and associated recording equipment for acquiring or recording three dimensional imagery as a sequence of partial discernibly different angles of view on separate positions of each separate frame of film or video cameras and where each partial different angle of view is acquired or recorded with identifying data to identify the position of each partial angle of view on any frame or frame in any sequence of frames, preferably for the purpose of controlling the positions of optical grid transmissive and opaque segmentation in relation to displaying the angles of view.

Further proposed are cameras and associated recording equipment acquiring or recording three dimensional imagery as a sequence of complete or partial views from offset lenses, static or dynamic mirrors, and with film and video frame shutters scanning film and or video frames in conjunction with the acquisition or recording of whole or partial angles of view and in particular in conjunction with scanning angles of view on mirrors.

Fourth Aspect of the Invention

In a fourth aspect, the invention is directed to a method of transmitting a signal for broadcasting, recording, displaying, disseminating or downloading three dimensional imagery which includes transmitting a first component from which may be generated an imagery display including a succession of images initiated at predetermined intervals, and a second component for generating, in synchronism with said images, the aforementioned control signal or signals for an optical grid means of the first aspect of the invention.

By way of example, the transmission signal may contain more visibly distinct angles of view which may be an extension of any conventional signal or a new signal in which different angles of view are transmitted as complete, separate, frames for direct broadcast, recording, or storage for later broadcast or display or the signal may contain partial angles of view for transmission, broadcast, recording or display in conjunction, or sequence, with other partial angles of view for combination into complete angles of view together with signals for controlling the functions of optical grid positions in relation to the angles of view.

### Preferred and Practical Embodiments

It is now proposed to discuss the practical implementation of the invention in relation to the scanning function mentioned above in connection with the second aspect of the invention, and then in relation to the tunnelling function.

### BRIEF DESCRIPTION OF DRAWINGS

FIG. 1 is a simple representation of an optical grid in which opaque and transmissive grid elements can traverse progressively or sequentially across the grid.

FIG. 2 is a simple diagrammatic indication of how the orientation of the polarization may progressively change across a panel.

FIG. 3 is a not-to-scale diagrammatic representation of the optical relationship between a pair of viewer's eyes, a screen, and pair of intervening optical grids according to an embodiment of the invention.

### THE SCANNING FUNCTION

It will be appreciated by those skilled in the art of liquid crystal displays that such displays function by switching from states where the display is either opaque or transmissive or parts of the display are opaque and other parts transmissive. This is accomplished by switching the angle of rotation of polarisation of polarising materials within the display so that light passing through the display either passes through the display or part of the display or is extinguished by opposite polarisation. Switching the angle of rotation of polarisation within the panel, or display, determines whether the display is opaque or transmissive or what parts of the display are opaque or transmissive.

It will be appreciated also that is possible to form an optical grid on a liquid crystal display by polarising sections of the display selectively so as to form a row of opaque and transmissive sections typical of optical grids, or parallax barriers as they are otherwise called, and that these optical grids can be formed to any desired size or shape for application to imagery display screens as view differentiating opticals. It will be appreciated further that it is possible to reverse, or alter, the positions of opaque and transmissive sections on an optical grid so formed and thus reverse, or alter, views that can be seen through such grids, as well by the same functions it is possible to reverse, or alter positions from which views can be seen through such optical grids.

It is proposed, for a preferred embodiment of the invention, that optical grids formed on electro-optical panels and displays move positions within the period of each separate frame display so as the grids take up all discernibly different viewing positions for every frame display and so scan all discernibly different viewing positions of the displayed frame. FIG. 1 illustrates diagrammatically where non-opaque grid elements 5 formed at any positions traverse progressively, or sequentially, all positions between W and X or y and z to y5 and z5 which form opaque viewing elements 4 between the non opaque grid elements at any position.

It will be appreciated that optical grids can be formed on liquid crystal panels and similar electro-optical displays by arranging the polarisation within the panel or display so that alternating sections are polarised, either at opposite angles of rotation to extinguish light passing through that part of the system and so block views through those sections of the grid, or at identical, or similar, angles of rotation to allow light to pass through that part of the system and so permit viewing through those sections of the grid.

An electro-optical panel or display is proposed comprising polarising materials, or polarisation rotation materials, and field changing circuitry for rotating the polarisation of light passing through the panel or display in which the polarising layers are not fixed or held at either the same, substantially the same, or opposite rotations but are fixed or held in progressively increasing or decreasing rotations, or segments of rotations, over the horizontal length of the panel or display so that sections of the panel formed into the alternating opaque and transmissive elements of an optical grid can be formed progressively, or sequentially, over the entire horizontal length of the grid by shifting polarisation rotation progressively horizontally as fields are switched progressively through the panel and completely within the time period of image or display frames.

It is proposed that optical grids formed on electro-optical panels and displays move positions within the period of each frame display of imagery containing two or more angles of view simultaneously, or substantially simultaneously, progressively, or sequentially, so as to progressively, or sequentially, take up all discernibly different positions for any particular frame display and so scan all discernibly different viewing positions of the frame display by progressively rotating increasing or deceasing horizontal progressions of opposite angles of polarisation between the display and the grid or within the grid so as progressively move the positions of opaque and transmissive elements set to form the grid so that all opaque and transmissive elements forming the grid progressively traverse the grid during the period of every frame change of the imagery.

It is proposed that optical grids formed on electro-optical panels or displays move positions within the period of each frame display of imagery containing two or more angles of view simultaneously, or substantially simultaneously, progressively, or sequentially, so as to progressively, or sequentially, take up all discernibly different viewing positions for every frame display and so scan all discernibly different positions for every frame display by progressively rotating increasing or decreasing horizontal progressions of opposite angles of polarisation between grids and displays, or within grids so as to progressively, or sequentially, move the positions of opaque and transmissive elements forming the optical grid so that opaque and transmissive elements progressively, or sequentially, traverse the screen during the period of every frame change by progressively, or sequentially, rotating horizontally progressive opposite polarising rotations between the grid and the screen or between the polarising materials and polarising layers of the grid.

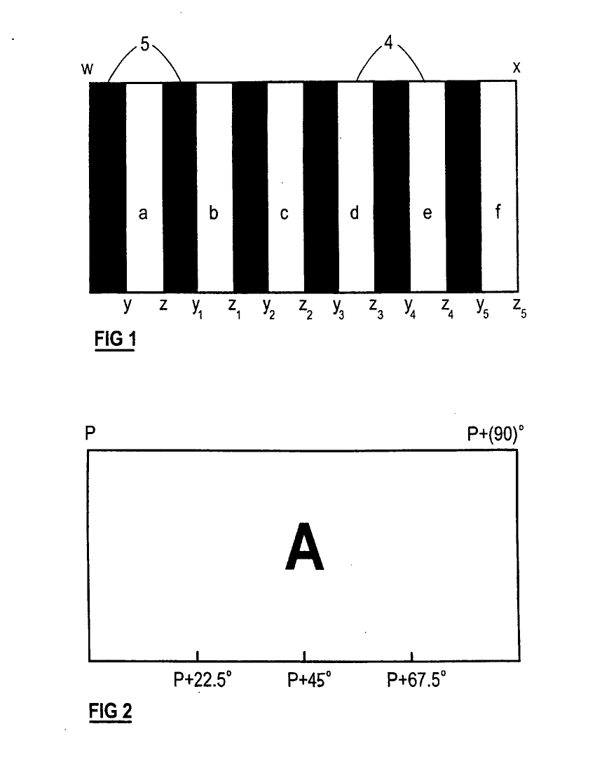

It is proposed that optical grids formed on electro-optical panels or displays move positions within the period of each frame display of imagery containing two or more discernibly different angles of view simultaneously, or substantially simultaneously, progressively, or sequentially, so as to progressively, or sequentially, take up all discernibly different positions for every frame display and so scan all discernibly different viewing positions for every frame display by progressively, or sequentially, rotating increasing or decreasing horizontal progressions of opposite angles of rotation between grids and displays or within grids so as to progressively, or sequentially, move the positions of opaque and transmissive elements forming the optical grid so that opaque and transmissive elements forming optical grids progressively, or sequentially, traverse the screen during the period of every frame change by progressively, or sequentially, rotating horizontally progressively increasing or decreasing opposite polarising rotations between the grid and the screen or between the polarising materials and polarising layers of the grids or between grids where in either case polarising materials and materials for rotating polarisation are fixed or held in a horizontally graduated progression, or sequence, of polarising rotations so as to rotate in horizontally graduated opposite progressions as current flows through the electro-optical panel or display progressively, or sequentially, changing the fields controlling the rotations of all polarising materials. This is depicted in FIG. 2, where the rotation of the polarisation of panel A changes progressively horizontally.

Optical grids so formed, displayed and moved may comprise grid sizes and shapes as preferred and may comprise grids with vertical opaque and transmissive elements or with opaque and transmissive elements set at angles to the vertical for the purpose of displaying three dimensional imagery with vertical as well as horizontal dimension. Opaque and transmissive optical grid elements set at angles to the vertical may reverse or change positions in relation to angles to the vertical with or within the frame changes of imagery displays as desired.

The Tunnelling Function

It will be appreciated by those skilled in the art that optical grids separate imagery displayed through such grids to the eyes mainly along the focal axis of the grid.

It is proposed, for the preferred embodiment of the invention, that for any particular imagery where grids are to display the imagery completely separately and exclusively to the eyes at more than one viewing position, the positions of the grid elements change in relation to that viewing position so the focal axis of the grid lies along that direction. Optical grids may be formed between one electro-optical panel and display screens, between the polarising materials of an electro-optical panel, between vertically separated polarising layers in one complete panel, between more than one electro-optical panel and display screens, or between layers of display systems where part of the display is used to form a viewing grid for the rest of the display. It is proposed that the alignment of opaque and transmissive elements must be different for every discernibly different viewing position and change progressively, or sequentially, so as to traverse the panels progressively, or sequentially, within each frame display of imagery so as to separate the imagery displayed to all viewing positions of the screen completely separately and completely exclusively.

Here an optical grid is proposed that essentially turns viewing sections towards each viewing position as it progressively scans the screen to present one exclusive viewing position to every discernibly different viewing position, turning to every viewing position as it moves, as though a pair of virtual binocular viewers was traversing every point for observing the screen so that the binoculars seem always to be at every viewing position. This illustration of tangible viewing positions that can be readily discerned from other positions where three dimensional imagery cannot be seen properly will be understood by anyone who has actually experimented with such devices and will have seen the display of three dimensional imagery appear on moving towards the central viewing position and disappear on moving away from it. This effect is generally called “tunnelling”, an effect analogous to both eyes looking down separate tunnels to left views for left eyes and right views to right eyes and as such it engrosses exactly the same idea as a visibly distinct binocular view for the eyes. The whole point is to have tunnelling to every viewing position.

To accomplish this the following proposal is made for a preferred form of the invention in its second aspect, ie. an electro-optical viewing grid is proposed where opaque and transmissive elements of the grid change in shape, size, and relative position progressively in traversing electro-optical panels, or displays, so as to form an arc of focal axes around the screen in which the alignment of opaque and transmissive elements within the grid and between the grid and the screen change progressively, or sequentially, so as to display imagery on the screen simultaneously, or substantially simultaneously, for left eyes completely, separately and exclusively to every left eye viewing position within the screen arc of view and imagery for right eyes completely, separately, and exclusively to every right eye viewing position by maintaining simultaneously, or substantially simultaneously, complete, separate and exclusive viewing positions for left and right imagery at every grid position.

An electro-optical grid is also proposed comprising multiple separated electro-optical layers onto which two different and separated electro-optical grids can be formed and positioned at different positions on the panel or display and at different positions to each other so that the alignment of the two separated rows of opaque and transmissive elements forming the grids progressively, or sequentially, traverses the panel or display while progressively, or sequentially, changing the relative positions of the opaque and transmissive elements so as to present exclusive complete viewing positions simultaneously, or substantially simultaneously, to all visibly distinct viewing positions around the panel or display within the time period of any frame change of the display.

Optical grids completely and exclusively separating angles of view to the eyes can be applied to displaying three dimensional imagery containing two visibly distinct angles of view, or more than two visibly distinct angles of view, or as many visibly distinct angles of view for each viewing position as there are completely separate and exclusive viewing positions effectively provided by any particular viewing grid. In short, the arrangement permits the display of the multiplicity of angles of view contained in the visual volumes normally apprehended by human sight. The number of angles of view presented at any time will depend on whether multiple angles of view are required. When displays are intended for audiences located substantially in front of displays a limited number of angles of view may be sufficient for such viewing arcs and the number may be that sufficient to produce visual effects through the comparison of a number of small angles of view rather than risking potential eyestrain by displaying a few large angles of view.

Where great accuracy of placement in remote control is required, many angles of view may be displayed to provide adequate visual references for precise location, observation and manipulation. In this regard and because of concerns expressed by experts in eye care and medicine, it seems that some regulation of the angles of view displayed on three dimensional imagery systems is well overdue, at least for displays intended for the public and especially for displays intended for juveniles. Here it should be noted that very small angles of view may have considerable value in practical application too, particularly for displays not usually considered appropriate subjects for three dimensional imagery.

These are displays of text and figures rather than the illustrations and photography that normally appears in three dimensional displays. A great deal of time is spent by millions of people viewing text and figures on displays at only one angle of view. Experiments conducted by the authors of this application and others suggest that small complementary angles of view are more comfortable to look at for long periods than single angles of view and consequently may be a preferable display for those having to watch display screens for long periods, and particularly those who work at them. The reason why small complementary angles of view seem more comfortable to look at for long periods than single angles of view is not known to the authors of this application, who can only report that it seems to be a general response of many observers of their displays and it is suggested that the reason may have something to do with the fact that humans are used to seeing everything in dimension and consequently displays allowing the normal eye functions that produce perception of dimension will be more suitable to most people. In view of the obviously exploding increases in use of display screens throughout the world, this would seem to be another area where it is timely for investigation by appropriate authorities to establish if the use of display screens can affect sight.

Three dimensional imagery displayed through such a progressively position aligning electro-optical grid may be composed from drawings, illustrations, photographs, slides, films, video tapes, discs, microfiche, microchips, computer tapes discs and microchips, X-ray film tapes discs and microchips, infra-red photographs film tapes discs and microchips, ultra-sonic films tapes discs and microchips, imagery generated wholly or partially in computers on films tapes discs or microchips, imagery from CAD CAM equipment on film tapes discs or microchips, imagery acquired from CAT scanners on film tapes discs or microchips, imagery acquired from other scanning functions such as resonance and absorption scanning on film tapes discs or microchips, and from computer systems, programmes and specific purpose software packages. The imagery may be immediately displayed, recorded, stored, broadcast or transmitted.

It is proposed that where more than two images, or more than two angles of view are acquired, recorded, transmitted, broadcast or displayed, time coding or similar information may be included with the image information to control the positions of the electro-optical grid configuration in relation the viewing positions of the imagery as it appears in frame.

A view to be seen from the left of the display will appear in frame when the electro-optical grid is positioned to display that view, a view from the right when the grid is configured for right view positions, a view in front when the grid and the imagery behind it would present a view to and from the front etc.

Illustrative Embodiment

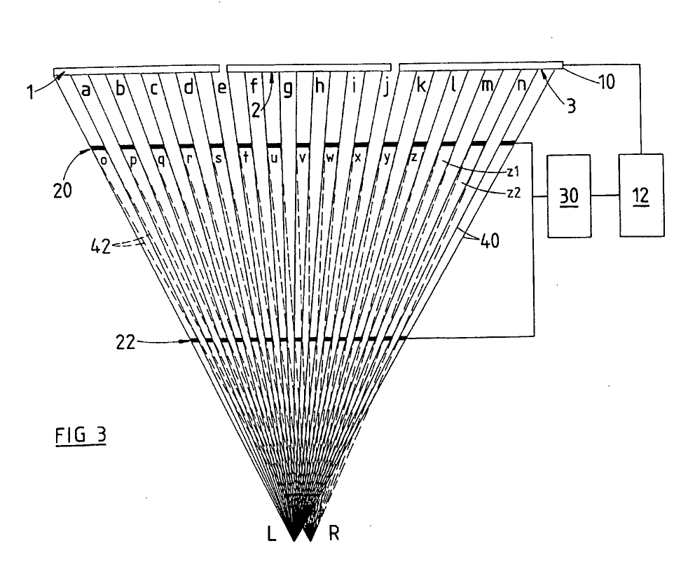

FIG. 3 displays left and right eyes, L and R, viewing a screen 10 in three different positions, 1, 2, and 3, that are any positions to the left, in front, and to the right of the eye viewing positions L and R respectively. Two parallel electro-optical grid segments are indicated at 20, 22. These grid segments are effectively at the one different position in all cases where the left eye L has an unrestricted view through both grids to half the imagery on all of the screens as depicted by any number of image segments a to n. Left views are indicated by full lines 40, and right views by broken lines 42.

Screen 10 provides a means for retaining an imagery display as a succession of images initiated at predetermined intervals by device 12, which may be, eg, any of the abovementioned devices. Control signals for grids 20, 22 are applied by master controller 30.

It will be appreciated that FIG. 3 is not to scale and that the two grids would in reality be relatively much closer together. Also, the depiction of three screen positions is cleaner to illustrate than one screen with three eye positions.

This schematic illustration demonstrates that it is possible to position two parallel electro-optical grids to provide an exclusive viewing position from any position. The diagram illustrates also that if the grids move either progressively, or sequentially, to traverse the screen this arrangement can be maintained to provide a complete as well as an exclusive view of the screen to any viewing position. The diagram illustrates also that right eye viewing position R is blocked by grid segments 20 at all right eye viewing positions, o to z2, illustrating that reversing the arrangements applies also so that is possible to exclude views at all positions as well as reveal views to all positions. Thus, one provides an arrangement where left and right eyes can have both complete and exclusive views of a screen from any position.

The efficiency of the arrangement is determined by the distance between the screen 10, the grids 20 and 22 and the viewing positions L and R all in relation to the width of the image segments a to n. In practice the longer and narrower the viewing tunnel produced between the two grids scanning across the screen in individually changing positions to encompass all viewing positions, the more efficient the image separation. It is important to note that the image segments a to n, which may be any number depending on the size of the screen, can be relatively very small, ranging from a few millimetres to a few inches in the case of a very large screen for cinemas, and consequently the grid distances can be relatively tiny and relatively very close to the screen.

It should be noted also that while the arrangement can be applied to displays where segmented left and right images are aligned with the viewing left and right positions as they scan the screen this is not necessary to the arrangement. Complete left images can be scanned exclusively to left eyes, then complete right images scanned exclusively to right eyes, providing frame refresh rates are adequate for all images to appear simultaneously, or substantially simultaneously. It should be noted as well that while the arrangement provides for displaying different angles of view to every viewing position, in practice no more than four views (a left view, a middle to left view, middle to right view, and a right view) should be adequate for most applications and in most cases each individual angle of view may not need to exceed small angles for realistic dimension and accurate discernment of spatial relationships within the imagery. In practice, three polarising layers only may be needed to produce the two electro-optical grids.

It will of course be understood that the optical gid(s) may function in reflection rather than transmission mode so that the eyes see image segments that are reflected rather than transmitted at the grid(s).

1. (cancelled)

2. Three dimensional imagery including an imagery display having a succession of images initiated at predetermined intervals in time and means to provide, during each of said intervals and therefore for each of said images, a set of plural pairs of visually distinct angles of view of the respective image able to be scanned by left and right eyes respectively.

3. Three dimensional imagery according to claim 2 wherein the number of said pairs of visibly distinct angles of view is an even number.

4. Three dimensional imagery according to claim 2 wherein said pairs of visibly distinct angles of view are complementary about a common centre, parallel along a common horizontal axis.

5. Three dimensional imagery according to claim 2 wherein said pairs of angles of view have different common centres to provide a variety of different comparable focal points, or so as to contain vertical displacement between angles of view.

6. Three dimensional imagery according to claim 2 wherein said angles of view are provided simultaneously or sequentially but always so as to appear simultaneous to a viewer and at a frame refresh rate sufficient to substantially eliminate visible flicker.

7. Three dimensional imagery according to claim 2 wherein said angles of view are provided in and to different viewing positions.

8. Three dimensional imagery according to claim 2 wherein said angles of view are provided so that no two different views are displayed in or to a common viewing position during any sequence of display where persistence of vision could discern one view overlapping or superimposing on another view.

9. Three dimensional imagery according to claim 2 wherein each of said angles of view does not exceed 15°.

10. Apparatus for viewing an imagery display, including:
means for retaining said imagery display as a succession of images initiated at predetermined intervals in time;
an optical grid means arranged with respect to said imagery display retaining means so that the imagery display may be viewed through the grid means;
means for applying a control signal or signals to said optical grid means for causing progressive movement of transmissive/reflective and opaque zones across the means whereby said progressively moving transmissive/reflective zones provide a set of plural pairs of visually distinct angles of view of the imagery display able to be scanned by the left and right eyes respectively; and
wherein the control signal is applied and the optical grid means is arranged so that said set of pairs of visually distinct angles of view is provided during each of said intervals and therefore for each of said images.

11. Apparatus according to claim 10 wherein said control signal or signals include a progressive, or sequential, image scanning function horizontally across said optical grid means simultaneously with a progressive, or sequential, three dimensional image tunnelling function so that imagery can be seen only by both eyes simultaneously, or substantially simultaneously, at multiple or all discernibly separate and exclusive viewing positions over a contiguous arc in front of the display retaining means that comprises the area where imagery can be distinguished clearly.

12. Apparatus according to claim 10 wherein said imagery display retaining means is a cinematograph, video and/or projection apparatus screen on which the images are retained, and the predetermined interval is then the respective refresh period thereof.

13. Apparatus according to claim 10 wherein the number of said pairs of visibly distinct angles of view is an even number.

14. Apparatus according to claim 10 wherein said pairs of visibly distinct angles of view are complementary about a common centre, parallel along a common horizontal axis.

15. Apparatus according to claim 10 wherein said pairs of angles of view have different common centres to provide a variety of different comparable focal points, or so as to contain vertical displacement between angles of view.

16. Apparatus according to claim 10 wherein said angles of view are provided simultaneously or sequentially but always so as to appear simultaneously to a viewer and at a frame refresh rate sufficient to substantially eliminate visible flicker.

17. Apparatus according to claim 10 wherein said angles of view are provided in and to different viewing positions.

18. Apparatus according to claim 10 wherein said angles of view are provided so that no two different views are displayed in or to a common viewing position during any sequence of display where persistence of vision could discern one view overlapping or superimposing on another view.

19. Apparatus according to claims claim 10 wherein each of said angles of view does not exceed 15°.

20. Apparatus according to claim 10 wherein at least four visibly different said angles of view are displayed, two of the different angles of view having a common centre different to a common centre of the other two.

21. Apparatus according to claim 10 wherein all of said angles of view displayed for the left eye are displayed exclusively and separately at positions for the left eye in any sequence of display where persistence of vision could discern a left view overlapping or superimposed on a right view, and not displayed completely, exclusively and separately to left eyes, and all views displayed for the right eye are displayed exclusively and separately at positions for the right eye in any sequence of display where persistence of vision could discern a right view overlapping or superimposed on a left view, and not displayed completely, exclusively and separately to right eyes.

22. Apparatus according to claim 10 wherein said optical grid means includes an optical grid device formed on an electro-optical panel or display, wherein the grid device is arranged so that its configuration may be altered within each of said intervals so that the grid device takes up plural, discernibly different viewing positions of the imaging display.

23. Apparatus according to claim 22 wherein said optical grid device has multiple variable polarisation elements controllable for altering the elements between opaque and transmissive condition, and wherein the elements have angles of polarisation that progressively vary across the device whereby the application to the device of a control signal or signals for effecting said alteration of the elements causes a progressive movement of transmissive/reflective and opaque zones across the device as the conditions of the elements are successively altered between opaque and transmissive or reflective.

24. A method of viewing an imagery display comprising a succession of images initiated at predetermined intervals in time, the method including:
viewing the imagery display through optical grid means as transmissive/reflective and opaque zones are progressively moved across the optical grid means whereby said progressively moving transmissive/reflective zones provide a set of plural pairs of visually distinct angles of view of the imagery display able to be scanned by the left and right eyes respectively, wherein said set of pairs of visually distinct angles of view is provided during each of said intervals and therefore for each of said images.

25. An optical grid device formed on an electro-optical panel or display, wherein the grid device is arranged with respect to associated imagery display means so that its configuration may be altered for each image of a series of image displays initiated at predetermined intervals in time, so that the grid device provides, during each of said intervals and therefore for each of said images, a set of plural pairs of visually distinct angles of view of the respective image able to be scanned by left and right eyes respectively.

26. An optical grid device having multiple variable elements controllable for altering the elements between opaque and transmissive or reflective conditions, whereby the application to the device of a control signal or signals for effecting said alteration of the elements causes a progressive movement of transmissive/reflective and opaque zones across the device as the conditions of the elements are successively altered between opaque and transmissive or reflective.

27. A device according to claim 25 wherein said optical grid device includes a three dimensional imagery optical grid having parallel vertical strips of alternating opposite polarisation rotations through which two visibly distinct complementary angles of view are projected to form substantially aligned images on a screen composed of non polarisation diffusing material.

28. A device according to claim 25 or 27 wherein said optical device is an electro-optical panel including materials selected from polarising materials, and liquid crystal materials and materials.

29. A medium in which are stored image representations, or machine readable code from which may be generated an imagery display including a succession of images initiated at predetermined intervals in time, the medium further storing machine readable code for generating control signal or signals for optical grid means through which the imagery display may be viewed, which control signal or signals cause progressive movement of transmissive/reflective and opaque zones across the optical means whereby said progressively moving transmissive/reflective zones provide a set of plural pairs of visually distinct angles of view of the imagery display able to be scanned by the left and right eyes respectively, and wherein the control signal is applied and the optical grid means is arranged so that said set of pairs of visually distinct angles of view is provided during each of said intervals and therefore for each of said images.

30. A medium according to claim 29 wherein said control signal or signals are in synchronism with frames of said images that contain said visually distinct angles of view.

31. A method of transmitting a three dimensional imagery signal which includes transmitting a first component from which may be generated an imagery display including a succession of images initiated at predetermined intervals in time, and a second component for generating, in synchronism with said images, a control signal or signals for an optical grid means through which the imagery display may be viewed, which control signal or signals cause progressive movement of transmissive/reflective and opaque zones across the means whereby said progressively moving transmissive/reflective zones provide a set of plural pairs of visually distinct angles of view of the imagery display able to be scanned by the left and right eyes respectively, and wherein the control signal is applied and the optical grid means is arranged so that said set of pairs of visually distinct angles of view is provided during each of said intervals and therefore for each of said images.

32. A method according to claim 31 wherein said control signal or signals are in synchronism with frames of said images that contain said visually distinct angles of view.

33. A method of displaying or disseminating three dimensional imagery which includes generating an imagery display including a succession of images initiated at predetermined intervals in time, and applying in synchronism with said images, a control signal or signals to an optical grid means through which the imagery display may be viewed, which control signal or signals cause progressive movement or transmissive/reflective and opaque zones across the means whereby said progressively moving transmissive/reflective zones provide a set of plural pairs of visually distinct angles of view of the imagery display able to be scanned by the left and right eyes respectively, and wherein the control signal is applied and the optical grid means is arranged so that said set of pairs of visually distinct angles of view is provided during each of said intervals and therefore for each of said images.

34. A method according to claim 32 wherein said control signal or signals in synchronism with frames of said images that contain said visually distinct angles of view.

35. An optical grid device according to claim 26 wherein said elements are polarisation elements having angles of polarisation that progressively vary across the device.

36. A device according to claim 26 wherein said optical grid device includes an optical grid having parallel vertical strips of alternating opposite polarisation rotations through which two visibly distinct complementary angles of view are projected to form substantially aligned images on a screen composed of non polarisation diffusing material.

37. A device according to claim 26 wherein said optical device is an electro-optical panel including materials selected from polarising materials, and liquid crystal.
